(19) United States
(12) Patent Application Publication
(10) Pub. No.: US 2026/0261531 A1
(43) Pub. Date: Sep. 3, 2026

(54) DISCUSSION SUPPORT DEVICE, DISCUSSION SUPPORT METHOD, AND RECORDING MEDIUM

(71) Applicant: NEC Corporation, Tokyo (JP)

(72) Inventors: Shinji CHICHIBU, Tokyo (JP); Nozomi TABATA, Tokyo (JP)

(73) Assignee: NEC Corporation, Tokyo (JP)

(21) Appl. No.: 19/542,837

(22) Filed: Feb. 18, 2026

(30) Foreign Application Priority Data
Mar. 7, 2025 (JP) 2025-036352

(51) Int. Cl. H04L 51/02; G06F 40/35

(52) U.S. Cl. CPC H04L 51/02; G06F 40/35

(57) ABSTRACT

In order to provide, in an easy-to-understand manner, a user with contents of intermediate products generated in a discussion utilizing a plurality of generative Ais, in a discussion support device that is communicably connected to a plurality of generative AIs, a processor acquires setting information set by a user for a discussion. The processor activates a plurality of the generative AIs based on the setting information and causing the plurality of the generative AIs to conduct the discussion. The processor records contents of remarks of each generative AI. The processor analyzes the remarks of each generative AI and create contribution information indicating contribution to an outcome of the discussion. The processor outputs the contribution information. This enables users to quickly understand contribution information and thereby facilitates accurate decision making based on the discussion outcomes.

### INCORPORATION BY REFERENCE

This application is based upon and claims the benefit of priority from Japanese Patent Application 2025-036352, filed on March 7, 2025, the disclosure of which is incorporated herein in its entirety by reference.

### TECHNICAL FIELD

The present disclosure relates to a technology utilizing generative artificial intelligence (AI).

### BACKGROUND ART

In recent years, introduction of a system that generates an outcome a user wants by utilizing a plurality of generative AIs has progressed. With development of such a system, an environment that makes it possible to flexibly fulfill multiple users' needs is being put into place. Patent Document 1 discloses a system in which an answer device having a plurality of large language models (LLMs) appropriately answers a user's request.

Patent Document 1: Japanese Patent No. 7588752

### SUMMARY

In a case of utilizing a plurality of generative AIs, a large amount of intermediate products such as character strings and images are generated before an outcome is generated. Thus, in a case where a user who has checked the outcome wants to know how and why such an outcome has been generated, which of the generative AIs took an active part, and the like, it is necessary to decipher a large amount of intermediate products. For example, in a case where the intermediate products are in a chat format, it is necessary for the user to scroll all the way upward from the outcome displayed at the end and find a portion related to the outcome and the generative AI that took an active part, which causes a problem that it takes time and effort.

One object of the present disclosure is to provide, in an easy-to-understand manner, a user with contents of intermediate products generated in a discussion utilizing a plurality of generative AIs.

According to an example aspect of the present invention, there is provided a discussion support device that is communicably connected to a plurality of generative AIs, the discussion support device including:

at least one memory configured to store instructions; and

at least one processor configured to execute the instructions to:

acquire setting information set by a user for a discussion;

activate a plurality of the generative AIs based on the setting information and causing the plurality of the generative AIs to conduct the discussion;

record contents of remarks of each generative AI;

analyze the remarks of each generative AI and create contribution information indicating contribution to an outcome of the discussion; and

output the contribution information.

According to another example aspect of the present invention, there is provided a discussion support method executed by a discussion support device communicably connected to a plurality of generative AIs, the discussion support method including:

acquiring setting information set by a user for a discussion;

activating a plurality of the generative AIs based on the setting information and causing the plurality of the generative AIs to conduct the discussion;

recording contents of remarks of each generative AI;

analyzing the remarks of each generative AI and creating contribution information indicating contribution to an outcome of the discussion; and

outputting the contribution information.

According to a further example aspect of the present invention, there is provided a non-transitory computer-readable recording medium storing a program executed by a discussion support device that is communicably connected to a plurality of generative AIs and includes a computer, the program causing the computer to execute processing including:

acquiring setting information set by a user for a discussion;

activating a plurality of the generative AIs based on the setting information and causing the plurality of the generative AIs to conduct the discussion;

recording contents of remarks of each generative AI;

analyzing the remarks of each generative AI and creating contribution information indicating contribution to an outcome of the discussion; and

outputting the contribution information.

### EFFECT

According to the present disclosure, it is possible to provide, in an easy-to-understand manner, a user with the contents of intermediate products generated in a discussion utilizing a plurality of generative AIs.

### BRIEF DESCRIPTION OF THE DRAWINGS

FIG. 1 illustrates an example of a schematic configuration of a discussion support system according to the present disclosure;

FIGS. 2A and 2B are block diagrams illustrating examples of a hardware configuration of a server and a user terminal;

FIG. 3 is a block diagram illustrating an example of a functional configuration of the server;

FIGS. 4A and 4B illustrate examples of a setting screen;

FIG. 5 illustrates an example of remarks of each generative AI;

FIGS. 6A and 6B illustrate examples of an outcome screen;

FIG. 7 illustrates an example showing a remark history screen as a whole;

FIG. 8 illustrates an example of displaying some remarks in a state distinguishable from other remarks;

FIG. 9 is a flowchart illustrating an example of screen output processing by the server;

FIG. 10 is a block diagram illustrating a functional configuration of a discussion support device; and

FIG. 11 is a flowchart by the discussion support device.

### EXAMPLE EMBODIMENTS

Hereinafter, example embodiments of the present disclosure will be described with reference to the drawings.

### First Example Embodiment

### Overall Configuration

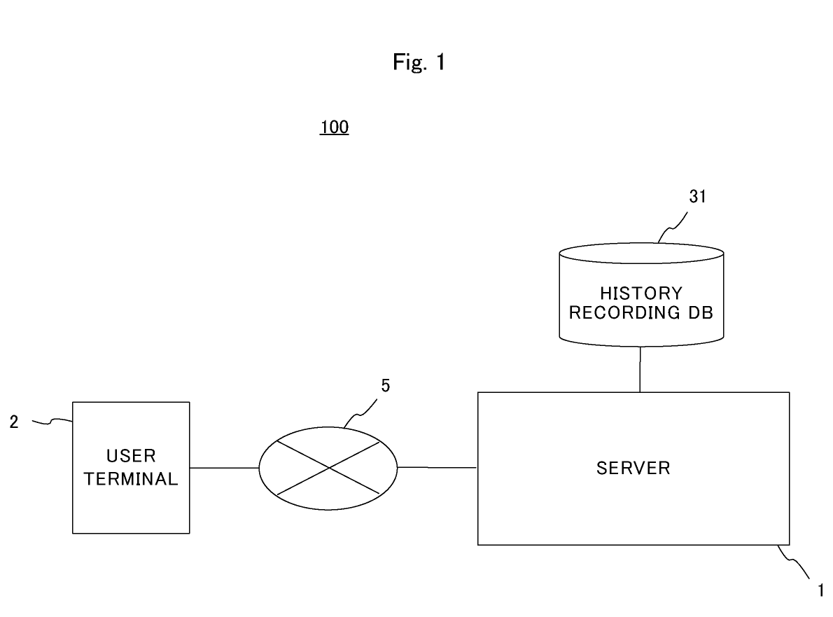

FIG. 1 illustrates an example of a schematic configuration of a discussion support system 100 to which a discussion support device of the present disclosure is applied. The discussion support system 100 is a system that visualizes and provides, in an easy-to-understand manner for a user, the contents of intermediate products generated in a discussion utilizing generative AIs. Here, the discussion is a discussion among a plurality of persons for the purpose of exchanging opinions or solving a problem, and includes a debate in the form of vigorous exchange of opposing opinions.

In the discussion support system 100 in FIG. 1, a server 1 and a user terminal 2 are communicably connected via a network 5 such as the Internet. The user is a person who receives an outcome of the discussion utilizing the generative AIs.

The user terminal 2, which is a smartphone, a tablet, a PC, or the like used by the user, transmits, to the server 1, setting information such as a theme of the discussion, generative AIs to be used, and a character to be set, and receives information regarding various screens from the server 1.

The server 1 is an information processing device that processes, stores, and transmits/receives various types of data, and the server 1 receives the setting information from the user terminal 2, and transmits, to the user terminal 2, contribution information indicating intermediate products having a high degree of contribution in the discussion. The server 1 is connected to a history recording DB 31 to be described later. The server 1 may be a virtual server in a cloud environment. The server 1 is an example of the discussion support device of the present disclosure.

### Hardware Configuration

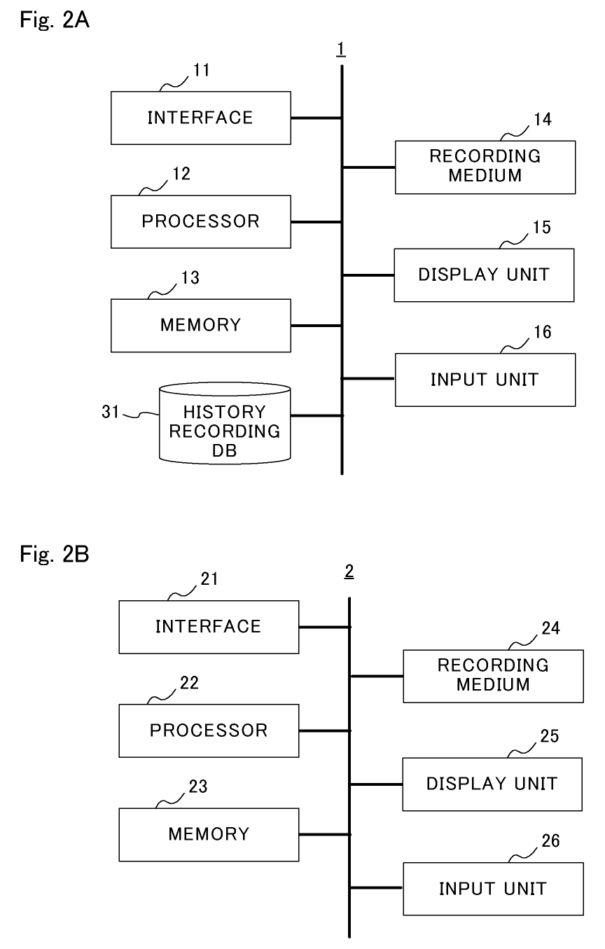

FIG. 2A is a block diagram illustrating an example of a hardware configuration of the server 1. As illustrated in the drawing, the server 1 includes an interface 11, a processor 12, a memory 13, a recording medium 14, a display unit 15, and an input unit 16. These components and the history recording DB 31 are connected to each other via a bus.

The interface 11 exchanges data with the user terminal 2. The interface 11 is used to receive the setting information from the user terminal 2 and transmit information regarding various screens including the contribution information to the user terminal 2.

The processor 12 is a computer such as a central processing unit (CPU), and controls the entire server 1 by executing a program prepared in advance. As the processor 12, it is possible to use a CPU, a Graphics Processing Unit (GPU), a Digital Signal Processor (DSP), a Micro Processing Unit (MPU), a Floating Point Unit (FPU), a Physics Processing Unit (PPU), a Tensor Processing Unit (TPU), a quantum processor, a microcontroller, a combination of these, or the like.

The memory 13 includes a read only memory (ROM), a random access memory (RAM), and the like. The memory 13 stores a program executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs to be executed by the processor 12. In a case where the server 1 executes screen output processing to be described later, a program recorded in the recording medium 14 is loaded into the memory 13 and executed by the processor 12.

The display unit 15 is, for instance, a liquid crystal display (LCD), and displays various images while the server 1 is operating. The input unit 16 is a keyboard, a mouse, a touch panel, or the like, and is used by an operator who manages the server 1.

The history recording DB 31 records the contents of remarks of each generative AI in a discussion utilizing a plurality of generative AIs. Specifically, the history recording DB 31 records, as history information, AI identification information for identifying the generative AIs used for the discussion, a character set for each generative AI, remarks of each generative AI and times at which the remarks were made, and the like. The history information may be recorded in association with the theme of the discussion and user identification information for identifying the user. The information to be recorded in the history recording DB 31 can be freely set.

FIG. 2B is a block diagram illustrating an example of a hardware configuration of the user terminal 2. As illustrated in the drawing, the user terminal 2 includes an interface 21, a processor 22, a memory 23, a recording medium 24, a display unit 25, and an input unit 26.

The interface 21 exchanges data with the server 1 via the network 5. The interface 21 is used to transmit setting information set by the user to the server 1 and receive information regarding various screens from the server 1.

The processor 22 is a computer such as a CPU, and controls the entire user terminal by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes a ROM, a RAM, or the like. The memory 23 stores a program executed by the processor 22. The memory 23 is also used as a working memory during execution of various types of processing by the processor 22.

The recording medium 24 is a non-volatile and non-transitory recording medium such as a disk-shaped recording medium or a semiconductor memory, and is attachable to and detachable from the user terminal 2. The recording medium 24 records various programs to be executed by the processor 22. The display unit 25 is, for instance, an LCD, and displays various images while the user is operating the user terminal 2. The input unit 26 is a touch panel or the like, and is used in a case where the user performs a predetermined operation.

### Functional Configuration

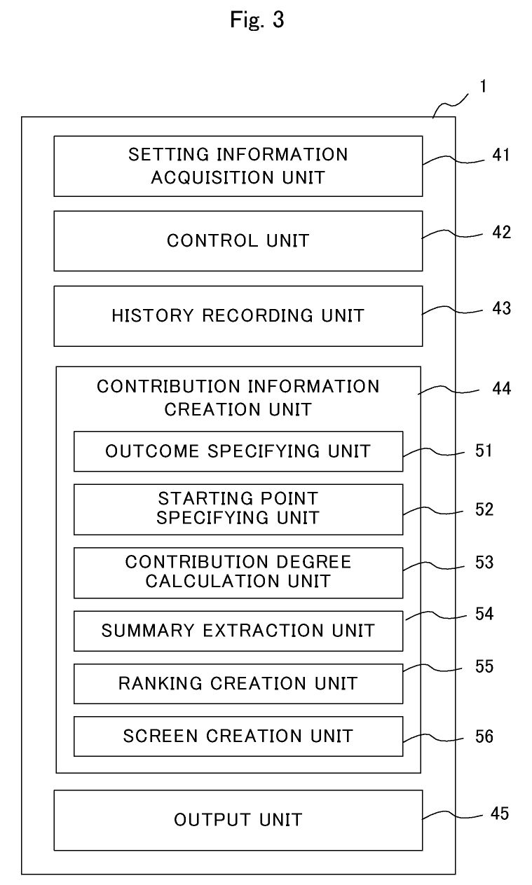

FIG. 3 is a block diagram illustrating an example of a functional configuration of the server 1. The server 1 functionally includes a setting information acquisition unit 41, a control unit 42, a history recording unit 43, a contribution information creation unit 44, and an output unit 45.

The setting information acquisition unit 41, the control unit 42, the history recording unit 43, the contribution information creation unit 44, and the output unit 45 are implemented by the processor 12 executing a program.

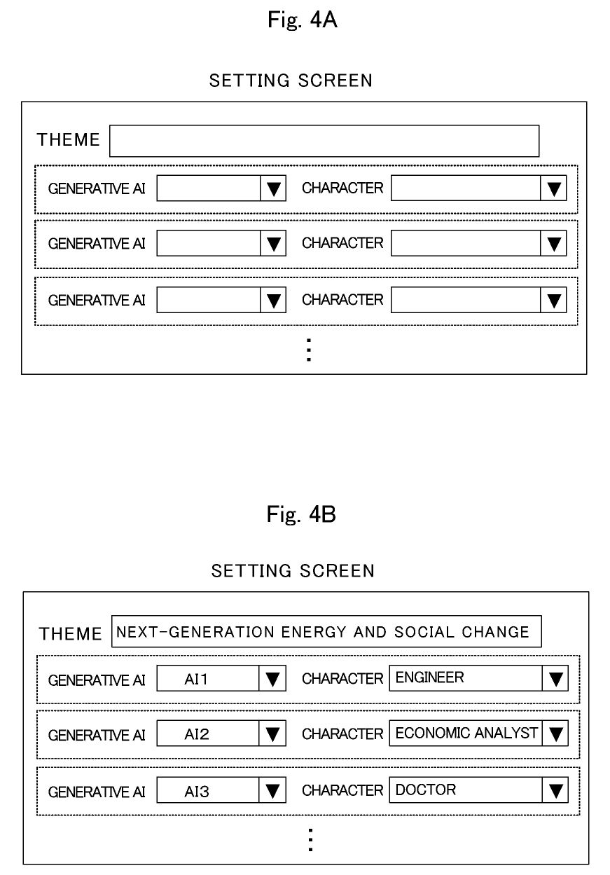

The setting information acquisition unit 41 acquires, from the user terminal 2, setting information such as the theme of the discussion set by the user, generative AIs to be used, and a character to be set for each generative AI. FIG. 4A and FIG. 4B illustrate examples of a setting screen.

As illustrated in FIG. 4A, the setting screen includes a theme field, and a plurality of generative AI fields and character fields. The theme field is a field for setting the theme of the discussion. The user may freely input a theme, or may select a theme from a plurality of predetermined options. As an example, it is assumed that the user has set “next-generation energy and social change” as the theme as illustrated in FIG. 4B.

The generative AI fields are fields for setting generative AIs to be used for the discussion. The user sets the generative AIs by selecting generative AIs from a plurality of options or inputting any generative AIs on the setting screen. Specifically, the generative AIs are various types of interactive AIs utilizing LLMs such as ChatGPT, and may be specially caused to learn specialized knowledge in, for instance, medical care or laws. The generative AIs used for the discussion are not limited to interactive AIs, and it is possible to apply any generative AIs such as data analysis AIs that present statistical data or numerical grounds, for instance.

The character fields are fields for setting a character of each generative AI. In a discussion using a plurality of generative AIs, by setting a different role for each generative AI, it is possible to conduct a more multilateral and deeper discussion. The character is a role to be set for each generative AI, and examples of the character include an “engineer” who provides a technical perspective, an “economic analyst” who considers a market or economic impact, and a “doctor” and a “lawyer” who have specialized knowledge. The user sets the character by selecting a character from a list of options including a plurality of characters or inputting any character on the setting screen. A character such as a “chairperson” or a “moderator” may be set to advance the discussion.

As illustrated in FIG. 4A, there are sets of a generative AI field and a character field. As an example, as illustrated in FIG. 4B, it is assumed that the user has configured settings to conduct a discussion using a generative AI “AI1” to which a character “engineer” is set, a generative AI “AI2” to which a character “economic analyst” is set, and a generative AI “AI3” to which a character “doctor” is set. While three generative AIs are used in FIG. 4B, the present invention is not limited thereto, and the number of generative AIs to be used can be freely set.

The control unit 42 activates a plurality of generative AIs based on the setting information, and conducts a discussion. Specifically, the control unit 42 conducts the discussion by inputting, based on the setting information, a prompt including a directive for setting a character for each generative AI and a directive for requesting to draw a final outcome through repeated exchange of opinions on the theme. The directive for requesting a final outcome can be freely set in accordance with the theme.

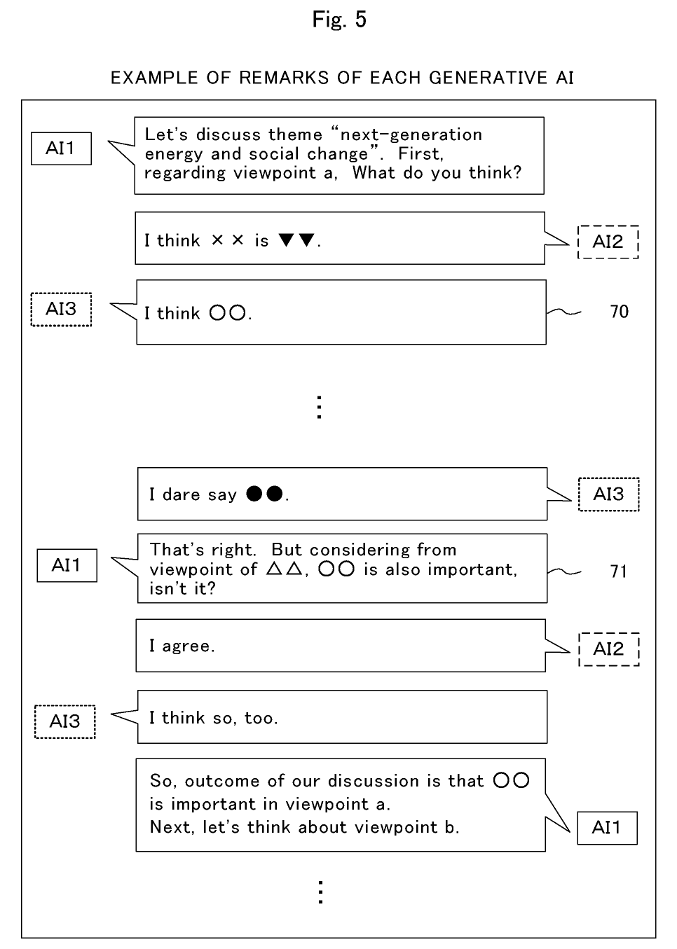

FIG. 5 illustrates an example of remarks of each generative AI in a discussion. The history recording unit 43 records the contents of remarks of each generative AI in a discussion utilizing a plurality of generative AIs. Specifically, the history recording unit 43 records, as history information in the history recording DB 31, AI identification information for identifying the generative AIs used for the discussion, a character set for each generative AI, remarks of each generative AI and the times at which the remarks were made, and the like. The history recording unit 43 may record the theme of the discussion and the user identification information in association with the history information.

The contribution information creation unit 44 analyzes the remarks of each generative AI based on the history information, and creates contribution information indicating contribution to the outcome of the discussion. The contribution information creation unit 44 includes an outcome specifying unit 51, a starting point specifying unit 52, a contribution degree calculation unit 53, a summary extraction unit 54, a ranking creation unit 55, and a screen creation unit 56.

The outcome specifying unit 51 specifies the outcome of the discussion based on the theme included in the setting information and the remarks of each generative AI. As an example, the outcome specifying unit 51 extracts a keyword indicating the outcome such as “conclusion”, “outcome”, and “summary” from the remarks of each generative AI, and specifies the outcome by analyzing context around the keyword. As another example, the outcome specifying unit 51 creates a prompt for requesting to specify the outcome based on the theme and the remarks of each generative AI, and specifies the outcome by inputting the prompt to a predetermined generative AI. In the example illustrated in FIG. 5, the outcome specifying unit 51 specifies the outcome of a viewpoint A as “○○ based on △△”. Specification of the outcome is not limited to these, and can be freely set.

The starting point specifying unit 52 specifies, from the remarks of each generative AI, a remark serving as a starting point from which the outcome is derived. As an example, the starting point specifying unit 52 specifies a remark including a keyword or a phrase directly connected to the outcome from the remarks of each generative AI, and specifies the remark serving as the starting point of the outcome by estimating a causal relationship between preceding and following remarks. As another example, the starting point specifying unit 52 creates a prompt for requesting to specify the remark serving as the starting point of the outcome from the remarks of each generative AI, and specifies the remark serving as the starting point by inputting the prompt to a predetermined generative AI. In the example illustrated in FIG. 5, the starting point specifying unit 52 specifies a remark 70 “I think ○○.” as the remark serving as the starting point. Specification of the remark serving as the starting point is not limited to these, and can be freely set. The remark serving as the starting point specified by the starting point specifying unit 52 is an example of the contribution information.

The contribution degree calculation unit 53 calculates the degrees of contribution indicating how the remarks of each generative AI have contributed to the outcome. The degree of contribution is a numerical value, and the higher the degree of contribution, the larger the numerical value, and the lower the degree of contribution, the smaller the numerical value. The degree of contribution is not limited thereto, and can be freely set to be indicated by, for instance, “high” or “low” without using numerical values.

As an example, the contribution degree calculation unit 53 calculates degrees of similarity between the remarks of each generative AI and the outcome, and calculates the degrees of contribution based on the degrees of similarity. In this case, a remark having a higher degree of similarity with the outcome obtains a higher degree of contribution by the calculation. As another example, the contribution degree calculation unit 53 creates a prompt for requesting to calculate the degrees of contribution of the remarks of each generative AI based on the outcome, and calculates the degrees of contribution of the remarks of each generative AI by inputting the prompt to a predetermined generative AI. Calculation of the degrees of contribution is not limited to these, and can be freely set. In the example illustrated in FIG. 5, it is assumed that a remark 71 “That's right. But considering from the viewpoint of △△, ○○ is also important, isn't it?” has obtained the highest degree of contribution by calculation by the contribution degree calculation unit 53.

The summary extraction unit 54 extracts a summary of the discussion based on the degrees of contribution from the remarks of each generative AI. As an example, the summary of the discussion includes a remark serving as a main point in producing an outcome and remarks before and after the remark. Specifically, the summary extraction unit 54 extracts, as a summary, a remark having the highest degree of contribution and remarks before and after the remark. In the example illustrated in FIG. 5, the summary extraction unit 54 extracts, as a summary, the remark 71 and remarks before and after the remark. As another example, the summary of the discussion may be all remarks in time series included in a range from the remark serving as the starting point to the remark having the highest degree of contribution. The summary extracted by the summary extraction unit 54 is an example of the contribution information.

The ranking creation unit 55 creates information indicating the generative AI that took an active part in the discussion. As an example, the ranking creation unit 55 creates a contribution degree ranking in which generative AIs having high degrees of contribution are ranked. As another example, the ranking creation unit 55 creates information in which the generative AI having the highest degree of contribution and the generative AI having made the remark serving as the starting point are set as a contribution degree MVP and a starting point MVP, respectively.

The ranking creation unit 55 may create a contribution degree ranking in which characters set for the generative AIs having high degrees of contribution are ranked, or may create information in which characters set for the generative AI having the highest degree of contribution and the generative AI having made the remark serving as the starting point are set as the contribution degree MVP and the starting point MVP, respectively. The information created by the ranking creation unit 55 is an example of the contribution information.

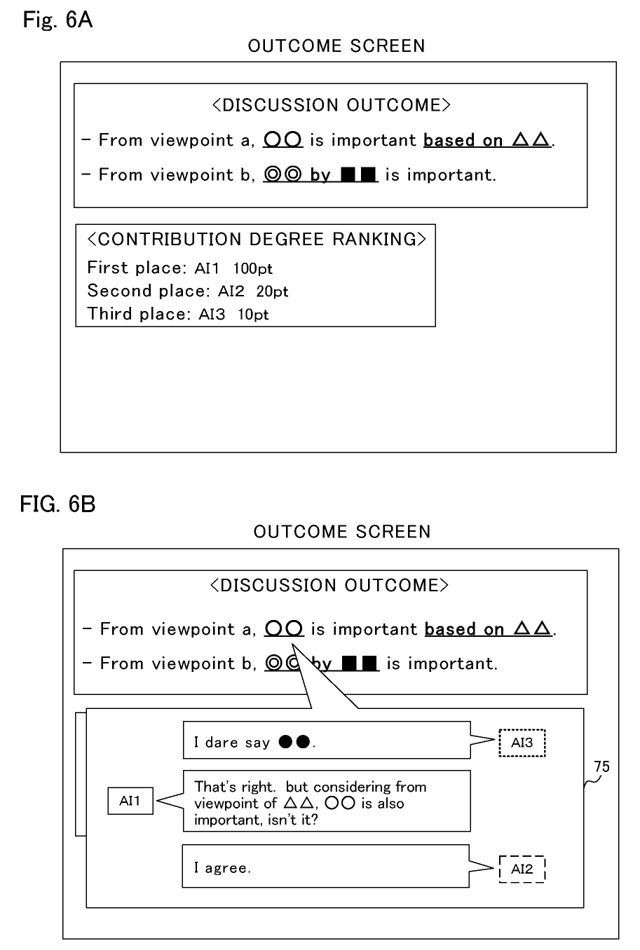

The screen creation unit 56 creates various screens. FIG. 6A and FIG. 6B illustrate examples of an outcome screen. In a case where the discussion ends, the screen creation unit 56 creates an outcome screen including a discussion outcome and a contribution degree ranking as illustrated in FIG. 6A. On the outcome screen, in a case where the user performs a predetermined operation, for instance, mouses over an underlined portion “○○ based on △△” in the discussion outcome, a summary 75 is displayed as illustrated in FIG. 6B. In a case where the user performs a predetermined operation, for instance, double-clicks the underlined portion “○○ based on △△” in the discussion outcome on the outcome screen, a remark history screen displaying a portion having the highest degree of contribution in a remark history is displayed. Specifically, the character string “○○ based on △△” in the discussion outcome is provided with a link to a portion with the highest degree of contribution in the remark history.

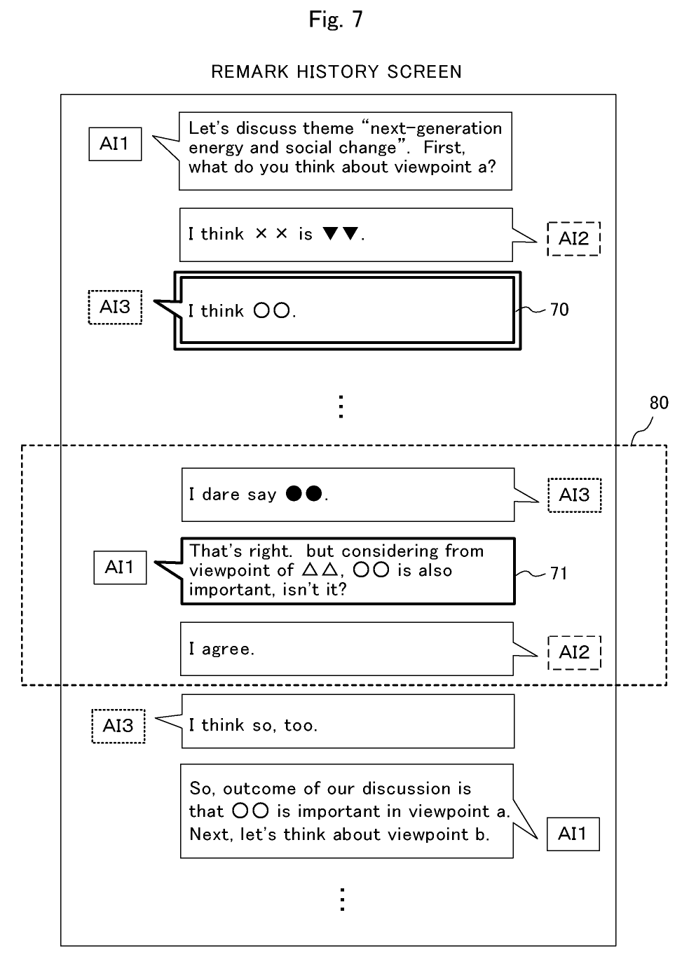

FIG. 7 illustrates an example showing the remark history screen as a whole. As illustrated in FIG. 7, the remark history screen is a screen displaying the whole remark history, and the portion normally displayed by the user terminal 2 is a range of a broken line 80. The user can perform a predetermined operation to display the whole by vertical scroll. In a case where the user double-clicks the underlined portion “○○ based on △△” in the discussion outcome on the outcome screen illustrated in FIG. 6A, the user terminal 2 displays the range of the broken line 80 on the remark history screen illustrated in FIG. 7. The range of the broken line 80 includes the summary 75 serving as the main point in producing the outcome, and specifically, displays the summary 75 including the remark 71 having the highest degree of contribution and remarks before and after that as illustrated in FIG. 7. The range of the broken line 80 is not limited thereto, and can be freely set to any range, for instance, from the remark 70 serving as the starting point to the remarks included in the summary 75.

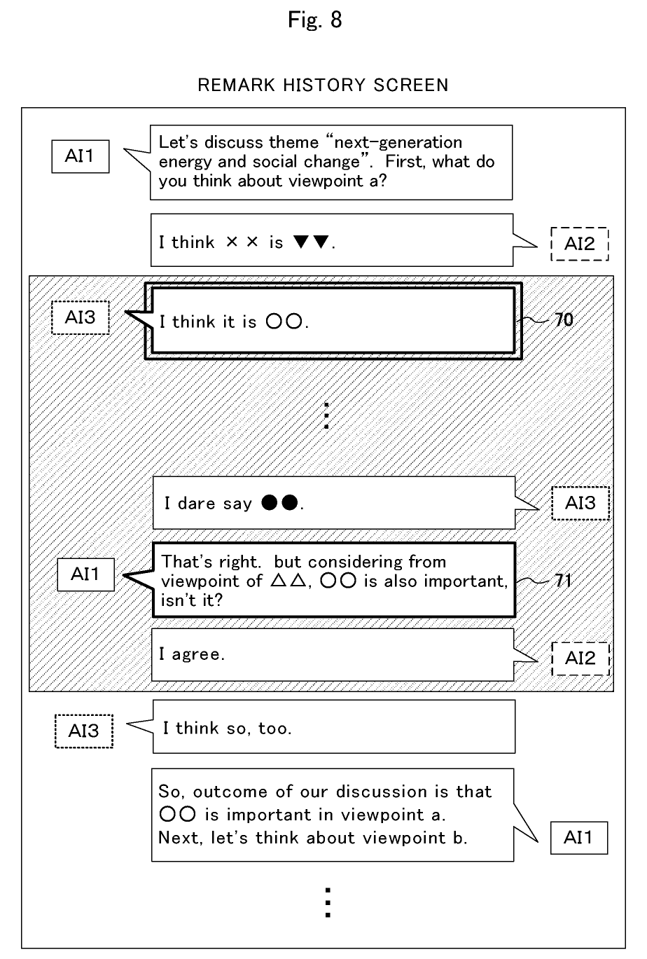

As illustrated in FIG. 7, the remark history screen displays each of the remark 70 serving as the starting point and the remark 71 having the highest degree of contribution in a state distinguishable from other remarks. The remarks included in the summary may be displayed in a state distinguishable from other remarks. As illustrated in FIG. 8, all remarks from the remark 70 serving as the starting point to the remarks included in the summary 75 may be displayed in time series in a state distinguishable from other remarks.

In a case where the discussion is ended, the output unit 45 transmits screen information related to the outcome screen to the user terminal 2. In a case of receiving a history request by a predetermined operation by the user on the outcome screen, for instance, a double click on a portion where a link is provided, the output unit 45 transmits screen information related to the remark history screen to the user terminal 2.

In the above configuration, the setting information acquisition unit 41, the control unit 42, the history recording unit 43, the contribution information creation unit 44, and the output unit 45 of the server 1 are examples of a setting information acquisition means, a control means, a history recording means, a contribution information creation means, and an output means, respectively, of the present disclosure.

### Screen Output Processing

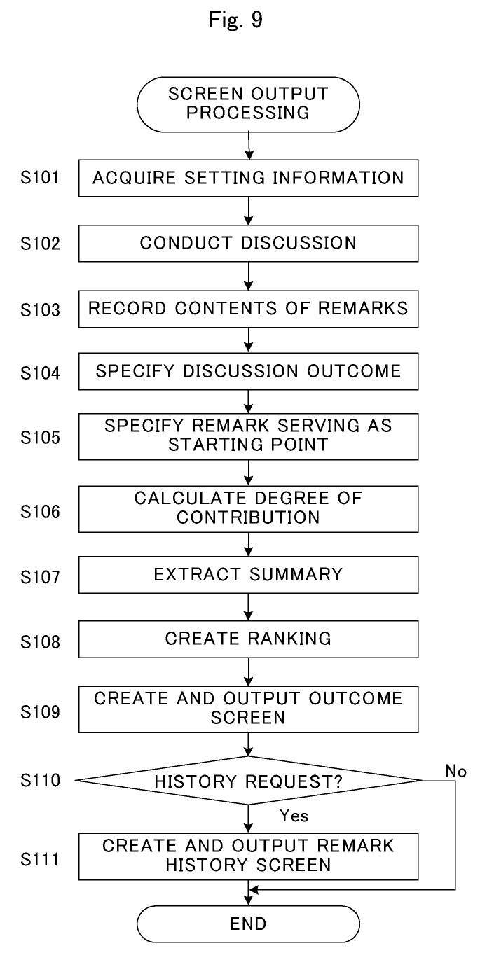

Next, the screen output processing by the server 1 will be described. FIG. 9 is a flowchart illustrating an example of the screen output processing by the server 1. This processing is achieved by the processor 12 illustrated in FIGS. 2A and 2B executing a program prepared in advance.

First, the server 1 acquires setting information from the user terminal 2 (step S101). Next, the server 1 conducts a discussion using a plurality of generative AIs based on the setting information (step S102). The server 1 records the contents of remarks of each generative AI in the discussion as history information in the history recording DB 31 (step S103).

Next, the server 1 refers to the history recording DB 31 and specifies an outcome of the discussion based on the setting information and the remarks of each generative AI (step S104). Based on the specified outcome, the server 1 specifies, from the remarks of each generative AI, the remark serving as the starting point from which the outcome has been derived (step S105). The server 1 calculates the degrees of contribution to the outcome of the remarks of each generative AI (step S106). The server 1 extracts a summary of the discussion from the remarks of each generative AI based on the degrees of contribution (step S107). The server 1 creates a ranking of the generative AIs in the discussion based on the remark serving as the starting point and the degrees of contribution (step S108).

Next, the server 1 creates an outcome screen and transmits information regarding the outcome screen to the user terminal 2 (step S109). The user terminal 2 displays the outcome screen based on the received information. In a case where the user wants to display the remark history and check the summary of the discussion or the remark serving as the starting point of the outcome, the user makes a history request by a predetermined operation on the outcome screen. The server 1 determines whether a history request has been received from the user terminal 2 (step S110). If no history request has been received (No in step S110), the server 1 ends the screen output processing. On the other hand, if a history request has been received (Yes in step S110), the server 1 creates a remark history screen, and transmits information regarding the remark history screen to the user terminal 2 (step S111). Thus, the server 1 ends the screen output processing.

According to the discussion support system 100 as described above, it is possible to visualize, as contribution information, how much the contents of remarks, which are intermediate products of each generative AI, have affected the finally obtained outcome of the discussion, and provide the user with the visualized information. The user can easily access the corresponding portion as necessary. Specifically, the discussion support system 100 provides information such as a contribution degree ranking and an MVP, so that the user can easily grasp which of the generative AIs took an active part in the discussion. By displaying the summary of the discussion together with the outcome, or by displaying, in an easy-to-understand manner, the remark serving as the starting point of the outcome or the remarks having high degrees of contribution in the remark history, it is possible to reduce the time and effort for the user to understand an intention with which the outcome has been generated.

### First Modification Example

In the above example embodiment, the server 1 may set a high degree of contribution for the remark serving as the starting point of the outcome, regardless of the degree of similarity. In this case, the user may set a parameter for each of the remark serving as the starting point of the outcome and the remark similar to the outcome in advance by performing a predetermined operation, and the server 1 may calculate the degrees of contribution of the remarks made by each generative AI in accordance with the set parameters. This makes it possible to visualize the remarks of the generative AI that took an active part in the discussion in an easy-to-understand manner in accordance with the parameters set by the user.

### Second Modification Example

The server 1 may specify, as a related remark, a remark having a degree of contribution equal to or more than a threshold among the remarks of each generative AI, and display the related remark in a state distinguishable from other remarks on the remark history screen. According to this, it is possible to visualize, in an easy-to-understand manner, the remark in which the degree of contribution to the outcome of the discussion is equal to or more than the threshold. The processing by the server 1 of the present modification example is an example of processing executed by a related specifying means.

### Second Example Embodiment

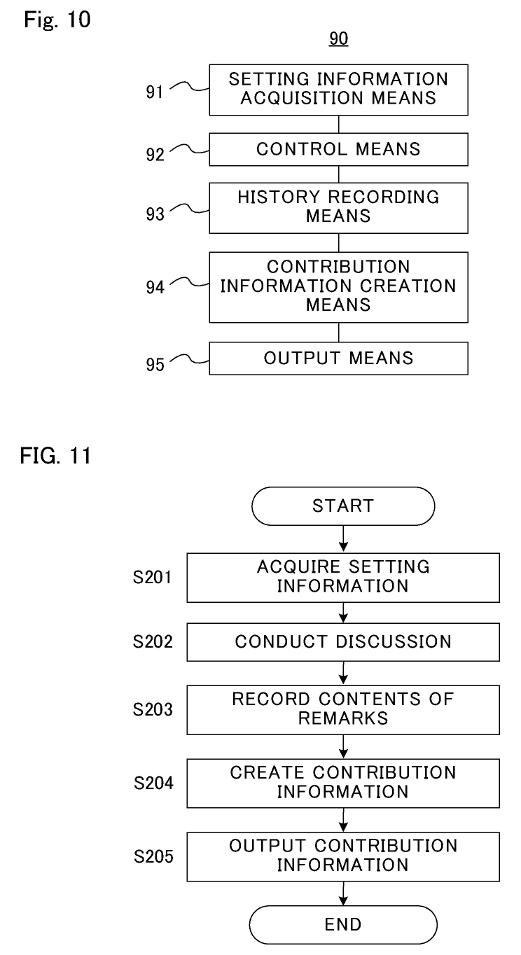

FIG. 10 is a block diagram illustrating an example of a functional configuration of the discussion support device according to the present disclosure. A discussion support device 90 includes a setting information acquisition means 91, a control means 92, a history recording means 93, a contribution information creation means 94, and an output means 95.

FIG. 11 is a flowchart illustrating an example of processing by the discussion support device 90. The discussion support device 90 is communicably connected to a plurality of generative AIs. The setting information acquisition means 91 acquires setting information set by a user for a discussion (step S201). The control means 92 activates a plurality of generative AIs based on the setting information and causes the plurality of generative AIs to conduct the discussion (step S202). The history recording means 93 records the contents of remarks of each generative AI (step S203). The contribution information creation means 94 analyzes the remarks of each generative AI, and creates contribution information indicating contribution to an outcome of the discussion (step S204). The output means 95 outputs the contribution information (step S205). According to the discussion support device 90, it is possible to visualize, in an easy-to-understand manner for a user, the contents of intermediate products generated in a discussion utilizing a plurality of generative AIs.

A part or all of the example embodiments described above may also be described as the following supplementary notes, but not limited thereto.

### Supplementary Note 1

A discussion support device that is communicably connected to a plurality of generative AIs, the discussion support device comprising:
a setting information acquisition means configured to acquire setting information set by a user for a discussion;
a control means configured to activate a plurality of the generative AIs based on the setting information and causing the plurality of the generative AIs to conduct the discussion;
a history recording means configured to record contents of remarks of each generative AI;
a contribution information creation means configured to analyze the remarks of each generative AI and create contribution information indicating contribution to an outcome of the discussion; and
an output means configured to output the contribution information.

### Supplementary Note 2

The discussion support device according to Supplementary Note 1, wherein the contribution information creation means includes:
an outcome specifying means configured to specify the outcome of the discussion;
a contribution degree calculation means configured to calculate degrees of contribution indicating how the remarks of each generative AI have contributed to the outcome; and
a summary extraction means configured to extract a summary of the discussion based on the degrees of contribution from the remarks of each generative AI, and the output means outputs the summary as the contribution information.

### Supplementary Note 3

The discussion support device according to Supplementary Note 2, wherein the summary extraction means extracts, as the summary, the remark having the highest degree of contribution and the remarks before and after the remark.

### Supplementary Note 4

The discussion support device according to Supplementary Note 2, wherein the contribution degree calculation means calculates the degrees of contribution based on the outcome and degrees of similarity of the remarks made by each generative AI.

### Supplementary Note 5

The discussion support device according to Supplementary Note 2, wherein
the output means outputs the contents of the remarks of each generative AI in time series in a case of acquiring a history request, and
the remarks included in the summary are output in a state distinguishable from other remarks.

### Supplementary Note 6

The discussion support device according to Supplementary Note 2, wherein
the contribution information creation means includes a starting point specifying means configured to specify the remark serving as a starting point of the outcome from the remarks of each generative AI,
the output means outputs the contents of the remarks of each generative AI in time series in a case of acquiring a history request, and
the remark serving as the starting point is output in a state distinguishable from other remarks.

### Supplementary Note 7

The discussion support device according to Supplementary Note 2, wherein the contribution degree calculation means calculates the degrees of contribution by inputting, to the generative AI, a prompt including a directive for calculating the degree of contribution of each remark to the outcome and the contents of the remarks of each generative AI.

### Supplementary Note 8

The discussion support device according to Supplementary Note 2, wherein
the contribution degree calculation means includes a ranking creation means configured to create a contribution degree ranking of the generative AIs based on the degrees of contribution, and
the output means outputs the contribution degree ranking as the contribution information.

### Supplementary Note 9

A discussion support method executed by a discussion support device communicably connected to a plurality of generative AIs, the discussion support method including:
acquiring setting information set by a user for a discussion;
activating a plurality of the generative AIs based on the setting information and causing the plurality of the generative AIs to conduct the discussion;
recording contents of remarks of each generative AI;
analyzing the remarks of each generative AI and creating contribution information indicating contribution to an outcome of the discussion; and
outputting the contribution information.

### Supplementary Note 10

A program executed by a discussion support device that is communicably connected to a plurality of generative AIs and includes a computer, the program causing the computer to execute processing including:
acquiring setting information set by a user for a discussion;
activating a plurality of the generative AIs based on the setting information and causing the plurality of the generative AIs to conduct the discussion;
recording contents of remarks of each generative AI;
analyzing the remarks of each generative AI and creating contribution information indicating contribution to an outcome of the discussion; and
outputting the contribution information.

### Supplementary Note 11

The discussion support device according to Supplementary Note 4, wherein
the contribution information creation means includes a starting point specifying means configured to specify the remark serving as a starting point based on the outcome, and
the contribution degree calculation means calculates the degree of contribution of the remark serving as the starting point to be high regardless of the degree of similarity.

### Supplementary Note 12

The discussion support device according to Supplementary Note 4, wherein
the discussion support device includes a parameter acquisition means configured to acquire a parameter set for each of the remark serving as a starting point of the outcome and the remark similar to the outcome,
the contribution information creation means includes a starting point specifying means configured to specify the remark serving as the starting point based on the outcome, and
the contribution degree calculation means calculates degrees of contribution of the remarks made by each generative AI based on the parameters.

### Supplementary Note 13

The discussion support device according to Supplementary Note 2, wherein
the contribution information creation means includes a starting point specifying means configured to specify the remark serving as a starting point based on the outcome, and
the output means outputs the contents of the remarks of each generative AI in time series in a case of acquiring a history request, and outputs all the remarks in time series included in a range from the remark serving as the starting point to the remarks included in the summary in a state distinguishable from other remarks.

### Supplementary Note 14

The discussion support device according to Supplementary Note 13, wherein the summary extraction means extracts, as the summary, all the remarks in time series included in a range from the remark serving as the starting point to the remark having the highest degree of contribution.

### Supplementary Note 15

The discussion support device according to Supplementary Note 2, wherein
a related specifying means configured to specify, as a related remark, the remark having a degree of contribution equal to or more than a threshold is included, and
the output means outputs the contents of the remarks of each generative AI in time series in a case of acquiring a history request, and outputs the related remark in a state distinguishable from other remarks.

Some or all of the configurations described in Supplementary Notes 2 to 8 and 11 to 15 dependent on the above-described Supplementary Note 1 can also be dependent on Supplementary Notes 9 and 10 by a dependency relationship similar to that in Supplementary Notes 2 to 8 and 11 to 15. Some or all of the configurations described as Supplementary Notes can be similarly dependent on not only Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Server

2 User terminal

11, 21 Interface

12, 22 Processor

13, 23 Memory

14, 24 Recording medium

15, 25 Display unit

16, 26 Input unit

31 History recording DB

41 Setting information acquisition unit

42 Control unit

43 History recording unit

44 Contribution information creation unit

45 Output unit

100 Discussion support system

1. A discussion support device that is communicably connected to a plurality of generative AIs, the discussion support device comprising:
at least one memory configured to store instructions; and
at least one processor configured to execute the instructions to:
acquire setting information set by a user for a discussion;
activate a plurality of the generative AIs based on the setting information and causing the plurality of the generative AIs to conduct the discussion;
record contents of remarks of each generative AI;
analyze the remarks of each generative AI and create contribution information indicating contribution to an outcome of the discussion; and
output the contribution information.

2. The discussion support device according to claim 1, wherein the processor is further configured to
specify the outcome of the discussion,
calculate degrees of contribution indicating how the remarks of each generative AI have contributed to the outcome,
extract a summary of the discussion based on the degrees of contribution from the remarks of each generative AI, and
the processor outputs the summary as the contribution information.

3. The discussion support device according to claim 2, wherein the processor extracts, as the summary, the remark having the highest degree of contribution and the remarks before and after the remark.

4. The discussion support device according to claim 2, wherein the processor calculates the degrees of contribution based on the outcome and degrees of similarity of the remarks made by each generative AI.

5. The discussion support device according to claim 2, wherein
the processor outputs the contents of the remarks of each generative AI in time series in a case of acquiring a history request, and
the remarks included in the summary are output in a state distinguishable from other remarks.

6. The discussion support device according to claim 2, wherein
the processor is further configured to specify the remark serving as a starting point of the outcome from the remarks of each generative AI,
the processor outputs the contents of the remarks of each generative AI in time series in a case of acquiring a history request, and
the remark serving as the starting point is output in a state distinguishable from other remarks.

7. The discussion support device according to claim 2, wherein the processor calculates the degrees of contribution by inputting, to the generative AI, a prompt including a directive for calculating the degree of contribution of each remark to the outcome and the contents of the remarks of each generative AI.

8. The discussion support device according to claim 2, wherein
the processor is further configured to create a contribution degree ranking of the generative AIs based on the degrees of contribution, and
the processor outputs the contribution degree ranking as the contribution information.

9. A discussion support method executed by a discussion support device communicably connected to a plurality of generative AIs, the discussion support method comprising:
acquiring setting information set by a user for a discussion;
activating a plurality of the generative AIs based on the setting information and causing the plurality of the generative AIs to conduct the discussion;
recording contents of remarks of each generative AI;
analyzing the remarks of each generative AI and creating contribution information indicating contribution to an outcome of the discussion; and
outputting the contribution information.

10. A non-transitory computer-readable recording medium storing a program executed by a discussion support device that is communicably connected to a plurality of generative AIs and includes a computer, the program causing the computer to execute processing comprising:
acquiring setting information set by a user for a discussion;
activating a plurality of the generative AIs based on the setting information and causing the plurality of the generative AIs to conduct the discussion;
recording contents of remarks of each generative AI;
analyzing the remarks of each generative AI and creating contribution information indicating contribution to an outcome of the discussion; and
outputting the contribution information.
